(19) United States
(12) Patent Application Publication
(10) Pub. No.: US 2013/0126044 A1
(43) Pub. Date: May 23, 2013

(54) FILL VALVE ASSEMBLY FOR FILLER DEVICE

(71) Applicants: Michael Fogg, Holland, MI (US); Lon Eding, Holland, MI (US)

(72) Inventors: Michael Fogg, Holland, MI (US); Lon Eding, Holland, MI (US)

(21) Appl. No.: 13/543,909

(22) Filed: Jul. 9, 2012

Related U.S. Application Data
(60) Provisional application No. 61/505,751, filed on Jul. 8, 2011.

(51) Int. Cl. B67D 7/42

(52) U.S. Cl. CPC B67D 7/42
USPC 141/311 R

(57) ABSTRACT

A fill valve assembly for use in association with a filler device, comprising: a vent tube; a valve adapter; a valve sleeve; and a seal member, wherein the fill valve assembly includes an internal, air-lock check valve which is especially suitable for filling small bottles of varying viscosity fill material.

### CROSS-REFERENCE TO RELATED APPLICATION

This application claims the benefit of U.S. Provisional Application Ser. No. 61/505,751, filed Jul. 8, 2011, entitled “Fill Valve Assembly for Filler Device,” which is hereby incorporated herein by reference in its entirety, including all references cited therein.

### BACKGROUND OF THE INVENTION

1. Field of the Invention

The present invention relates in general to a fill valve assembly, and more particularly, to a fill valve assembly for use in association with a filler device, that comprises an internal, air-lock check valve which is especially suitable for filling small bottles of varying viscosity fill material (e.g. fluid).

2. Background Art

Fill valve assemblies for use in association with filler devices have been known in the art for many years. While fill valve assemblies have become commercially available for use in association with filler devices, filling small bottles remains problematic.

Accordingly, it is an object of the present invention to provide a fill valve assembly which comprises an internal, air-lock check valve which is especially suitable for filling small bottles of varying viscosity fill material (e.g. fluid).

### SUMMARY OF THE INVENTION

Not Applicable.

### BRIEF DESCRIPTION OF THE DRAWINGS

The invention will now be described with reference to the drawings wherein:

FIG. 1 of the drawings is an exploded perspective view of an embodiment of a fill valve assembly fabricated in accordance with the present invention;

FIG. 2 of the drawings is a cross-sectional view of an embodiment of a fill valve assembly fabricated in accordance with the present invention;

FIG. 3 of the drawings is a perspective view of an embodiment of a vent tube fabricated in accordance with the present invention;

FIG. 4 of the drawings is a perspective view of an embodiment of a valve adaptor fabricated in accordance with the present invention;

FIG. 5 of the drawings is a perspective view of an embodiment of a valve sleeve fabricated in accordance with the present invention; and

FIG. 6 of the drawings is a perspective view of an embodiment of a seal washer fabricated in accordance with the present invention.

### DETAILED DESCRIPTION OF THE INVENTION

While this invention is susceptible of embodiment in many different forms, there is shown in the drawings and will be described in detail, a specific embodiment with the understanding that the present disclosure is to be considered as an exemplification of the principles of the invention and is not intended to limit the invention to the embodiment illustrated.

It will be understood that like or analogous elements and/or components, referred to herein, are identified throughout the drawing by like reference characters. In addition, it will be understood that the drawing is merely a schematic representation of a first embodiment of the invention, and some of the components may have been distorted from their actual scale for purposes of pictorial clarity.

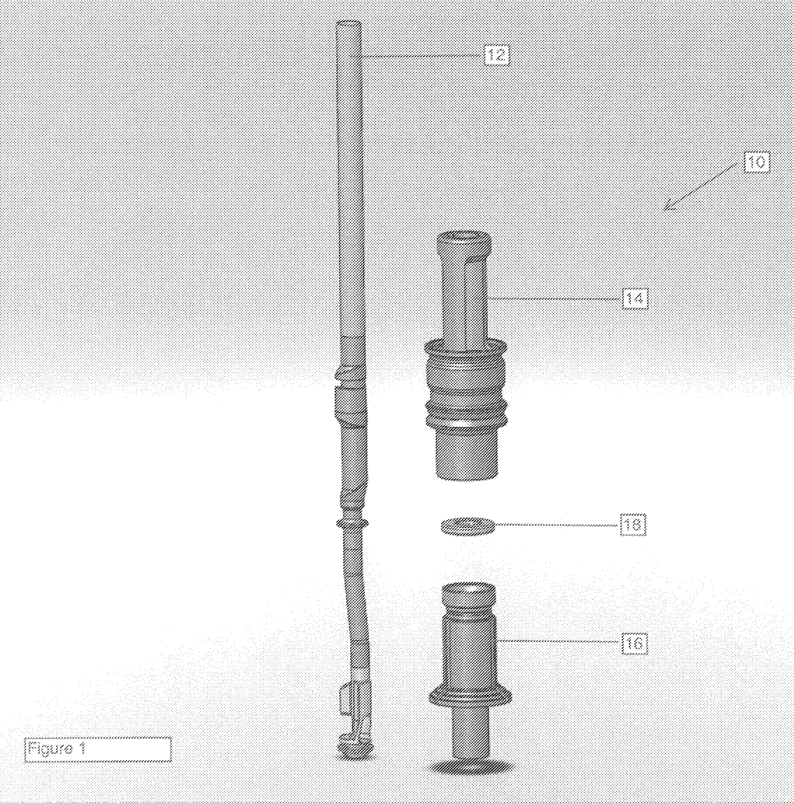

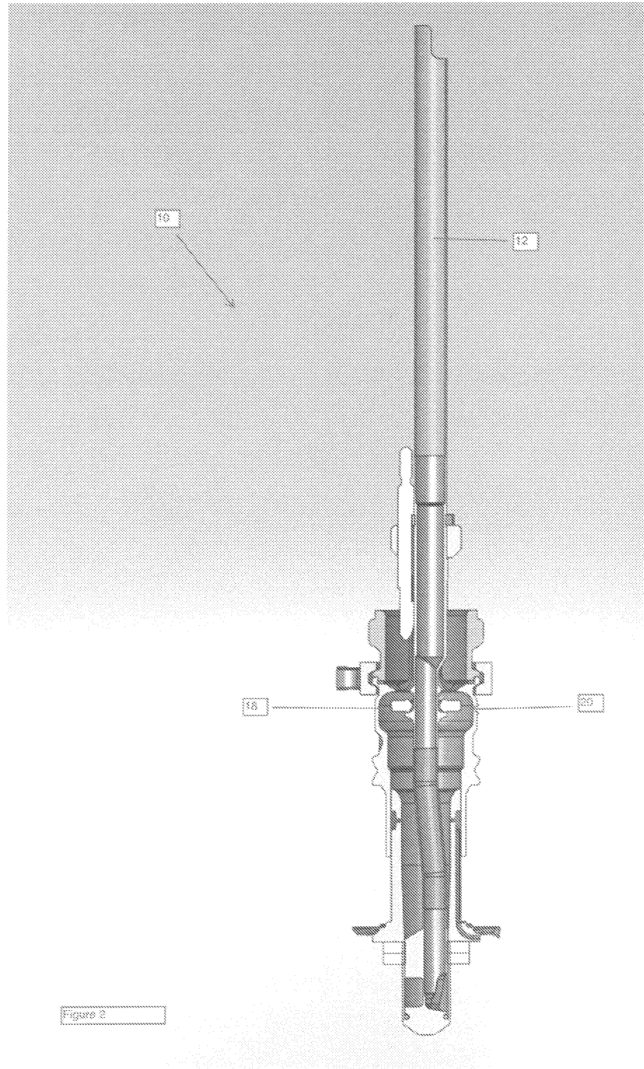

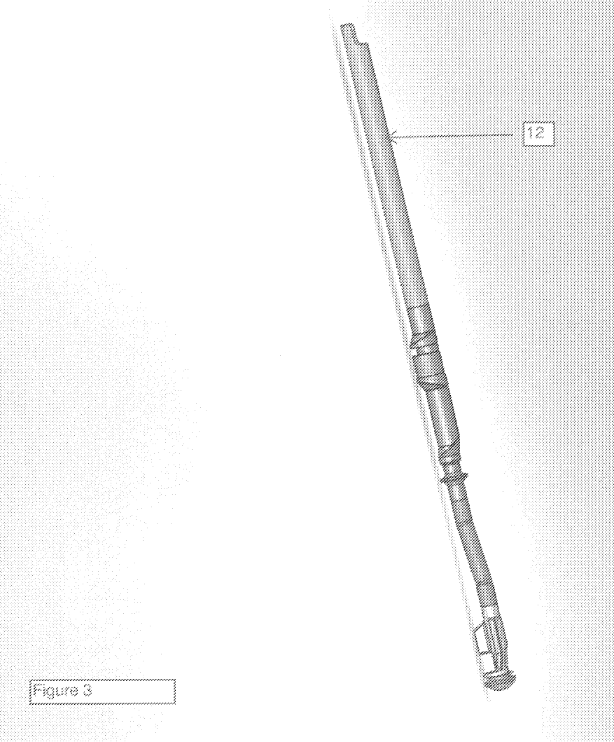

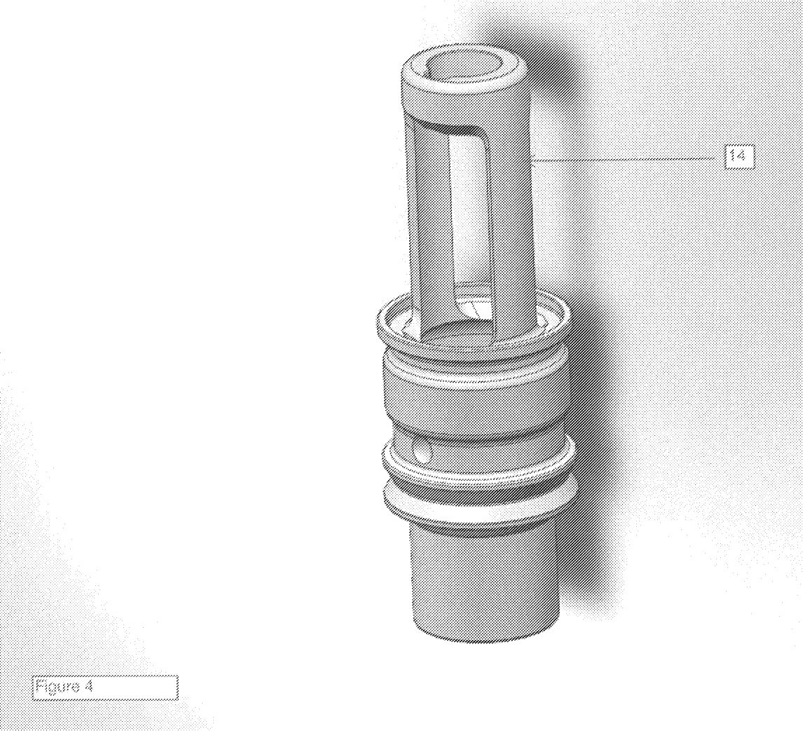

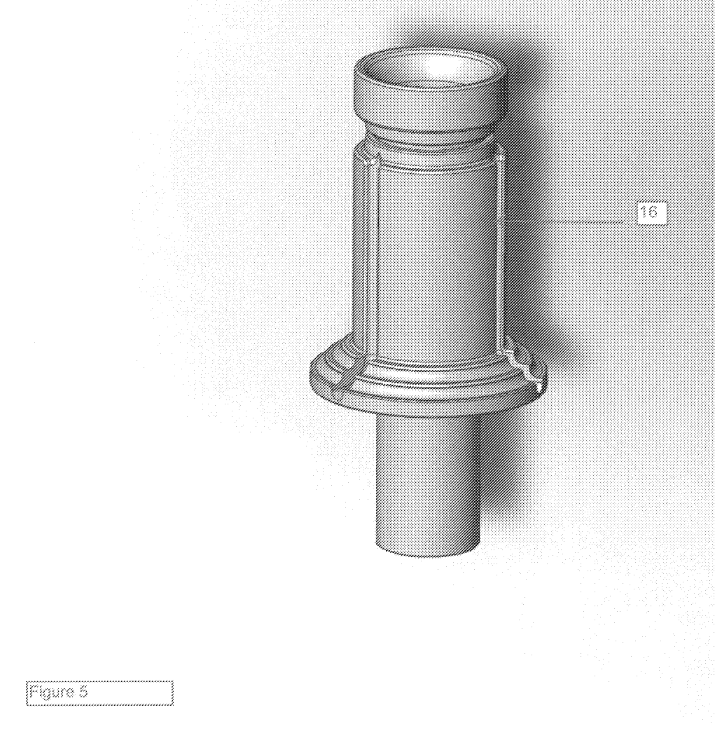

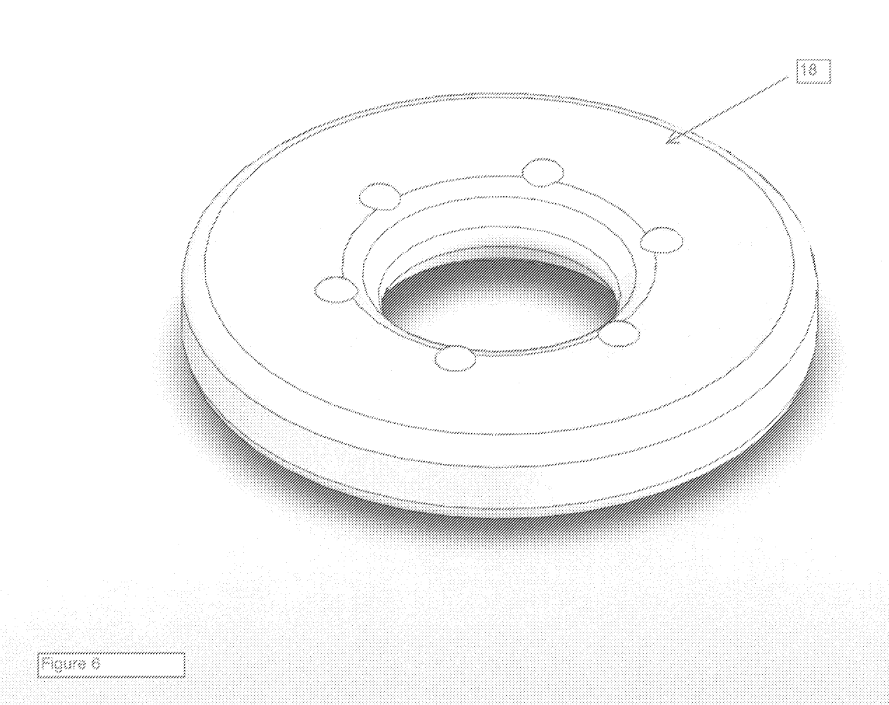

Referring now to the drawings, and to collectively to FIGS. 1-6, fill valve assembly 10 is provided which generally comprises vent tube 12, valve adapter 14, valve sleeve 16, and seal member 18. Fill valve assembly 10 is primarily intended for use in association with filler devices, which are generally capable of filling associated containers and/or bags with any one of a number of fill materials in solid, liquid, and/or gaseous states. Such filler devices may comprise linear filler devices, rotary filler devices and other devices which are capable of filling containers with fill material.

A plurality of fill valve assemblies are disclosed in U.S. Pat. Nos. 6,338,370 and 6,786,248, which are hereby incorporated herein by reference in their entirety.

In accordance with the present invention, fill valve assembly 10 includes internal, air-lock check valve 20—which is especially suitable filling small bottles of varying viscosity fill material (e.g. fluid).

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A fill valve assembly for use in association with a filler device, comprising:
a vent tube;
a valve adapter;
a valve sleeve; and
a seal member, wherein the fill valve assembly includes an internal, air-lock check valve which is especially suitable for filling small bottles of varying viscosity fill material.
